(19) United States
(12) Patent Application Publication
(10) Pub. No.: US 2002/0071423 A1
(43) Pub. Date: Jun. 13, 2002

(54) METHOD AND APPARATUS FOR VALUE ADDED CONTENT DELIVERY

(76) Inventors: MOJTABA MIRASHRAFI, PORTLAND, OR (US); MICHAEL F. BUONDONNO, BEAVERTON, OR (US); JOHN D. ELLIOTT, PORTLAND, OR (US); KENNETH L. KEELER, HILLSBORO, OR (US); KEITH A. PIRKL, VANCOUVER, WA (US); AL J. SIMON, HILLSBORO, OR (US); GEORGE L. TAYLOR, TIGARD, OR (US); MARK D. ZUBER, BEAVERTON, OR (US)

Correspondence Address: KAPLAN & GILMAN, LLP, 900 ROUTE 9 NORTH, WOODBRIDGE, NJ, 07095, US

(21) Appl. No.: 08/818,771

(22) Filed: Mar. 14, 1997

(51) Int. Cl. H04L 12/66

(52) U.S. Cl. 370/352

(57) ABSTRACT

A method and apparatus for value added content delivery receives from a client system a request for content which targets a network server. In response to the request, additional content associated with the network server is provided to the client system in addition to the requested content.

### BACKGROUND OF THE INVENTION

1. Field of the Invention

The present invention relates to the field of telecommunications and, in particular, to a method and apparatus for adding additional content to content received from a content provider in a network system.

2. Background Information

As computer technology has advanced the use of networks has continually increased. A network refers to a system which can couple together two or more computer systems such that the systems can communicate with one another. One current network which has recently gained widespread popularity is the Internet, which is a global network allowing individuals throughout the world to communicate with one another.

Communication over the Internet is typically between two computer systems referred to as a client system and a host system. The host system is the content provider. In other words, content (also referred to as information or data) is provided by the host system to the client system. Generally, this content can be modified only at the content provider. That is, whatever individual(s) has generated the content is the only individual(s) that can alter the content. The user of a client system can interact with the content, however, any new content provided by the content provider is done as directed by the individual(s) that created the content.

Currently, it is not possible to add to content provided by a content provider on the Internet other than by altering the content at the content provider. That is, a user at the content provider must physically change the content. However, it would be beneficial to provide a way to add to content from a content provider other than by modifying the content at the provider because it would allow the content to be customized at various other sites. For example, it would allow a single host system to provide content to a wide geographic range of sites while also allowing local information to be added for each local client system.

As will be described in more detail below, the present invention provides a method and apparatus for value added content delivery which achieves these and other desired results which will be apparent to those skilled in the art from the description that follows.

### SUMMARY OF THE INVENTON

A method and apparatus for value added content delivery is discussed herein. In accordance with the present invention, a request for content which targets a network server is received from a client computer system. In response to the receipt of the request, additional content is provided to the client system in addition to the requested content.

In one embodiment, the added content is associated with the network server.

In one embodiment, the added content provides a link to a service associated with the network server. The service is provided in response to the selection of the link.

In one embodiment, the added content is a Push-To-Talk™ service for automatically establishing and facilitating a voice call to a PSTN extension associated with the network server for the client computer system.

In one embodiment, the service is also provided by the apparatus of the present invention.

### BRIEF DESCRIPTON OF THE DRAWINGS

The present invention will be described by way of exemplary embodiments, but not limitations, illustrated in the accompanying drawings in which like references denote similar elements, and in which:

FIG. 1 is a block diagram of a network environment illustrating the value added content delivery of the present invention;

FIG. 2 is a flowchart illustrating the steps followed in the value added content delivery according to one embodiment of the present invention;

FIG. 3 is a flowchart illustrating the steps followed in the value added content delivery according to another embodiment of the present invention;

FIG. 4 illustrates an example of source code with additional content provided by an exemplary computer server according to one embodiment of the present invention;

FIG. 5 is a block diagram illustrating an exemplary communication system such as may be used with the present invention;

FIG. 6 is a block diagram illustrating the hardware elements of a bridgeport according to one embodiment of the present invention; and

FIG. 7 is a block diagram illustrating the software elements of bridgeport according to one embodiment of the present invention.

### DETAILED DESCRTION

In the following description, for purposes of explanation, specific numbers, materials and configurations are set forth in order to provide a thorough understanding of the present invention. However, it will be apparent to one skilled in the art that the present invention may be practiced without the specific details. In other instances, well known features are omitted or simplified in order not to obscure the present invention. Furthermore, for ease of understanding, certain method steps are delineated as separate steps, however, these separately delineated steps should not be construed as necessarily order dependent in their performance.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

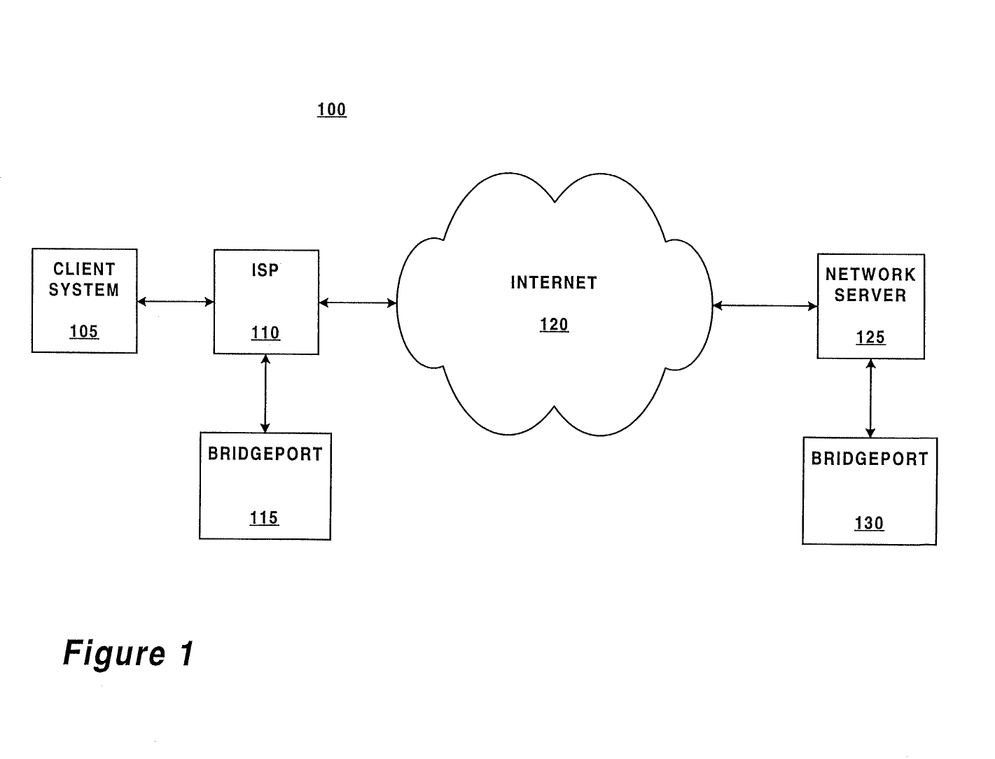

FIG. 1 is a block diagram of a network environment illustrating the value added content delivery of the present invention. Network environment 100 includes client system 105, Internet Service Provider (ISP) 110, bridgeports 115 and 130, Internet 120, and network server 125, coupled together as shown.

Client system 105 is intended to represent a broad range of hardware systems which can be coupled to Internet 120, such as a personal computer system.

ISP 110 routes data received from one system to another. Data can be received from either client system 105, bridgeport 115, or Internet 120 and can be directed to any of client system 105, bridgeport 115, and Internet 120.

Internet 120 can be any of a wide variety of conventional networks, including the Internet or an Intranet. In one embodiment, Internet 120 supports the HyperText Transmission Protocol (HTTP) and communicates with client system 105 and network server 125 using HTTP connections.

Network server 125 stores the content being requested by hardware systems such as client system 105. In one embodiment, this content is one or more HyperText Markup Language (HTML)-compatible web pages which can be browsed as part of the world wide web. Client system 105 requests a particular one of these web pages by placing, via ISP 110 and possibly bridgeport 115, as discussed in more detail below, a Uniform Resource Locator (URL) onto the Internet 120. The URL identifies network server 125.

Bridgeport 115 provides an identifier of the additional content to client system 105 according to one embodiment of the present invention. Requests from client system 105 are re-routed to bridgeport 115 prior to being placed onto Internet 120. Bridgeport 115 determines what additional content, if any, is to be provided to client system 105. The identifier of the additional content, if any, is first provided to client system 105, and the request is then placed onto Internet 120.

Bridgeport 130 provides the value added content to client system 105 according to another embodiment of the present invention. Bridgeport 130 may provide an identifier of additional content either in addition to or in place of that provided by bridgeport 115. Requests from client system 105 are received at network server 125 via ISP 110 and Internet 120. Upon receipt at network server 125, the request is re-routed to bridgeport 130, where the identifier of the appropriate additional content, if any, is forwarded to client system 105. As with bridgeport 115, the request is then placed onto the Internet 120 again, and routed to network server 125, which in due course receives the request and returns the requested content to client system 105.

It is to be appreciated that additional components can be added to and removed from network environment 100, and components of network environment 100 can be combined. By way of example, network environment 100 may include multiple additional client systems, bridgeports, and network servers coupled to Internet 120, or bridgeport 115 could be combined with ISP 110, or bridgeport 130 could be combined with network server 125.

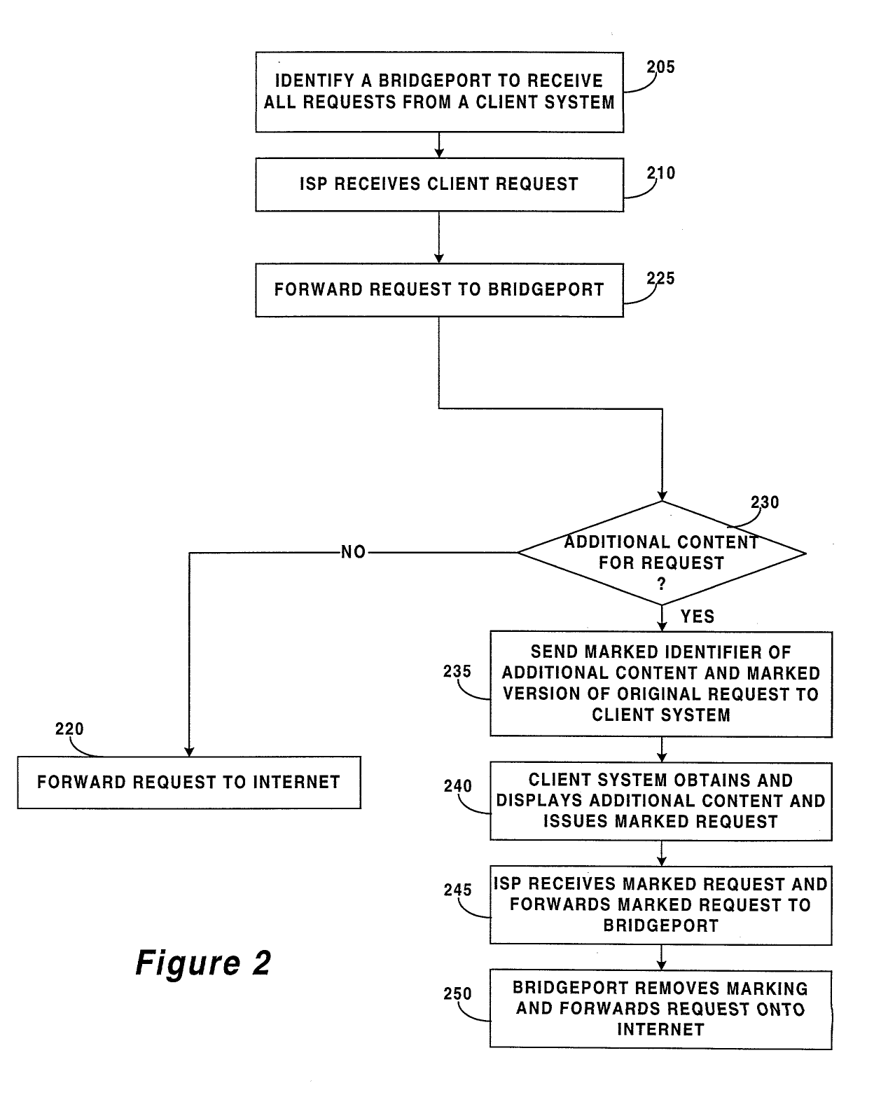

FIG. 2 is a flowchart illustrating the steps followed in the value added content delivery according to one embodiment of the present invention. In the flowchart of FIG. 2, it is presumed that bridgeport 115 of FIG. 1 is providing the identifier of the additional content. Bridgeport 115 is first identified as the recipient of all content requests originated from client system 115, step 205. In one embodiment, bridgeport 115 is identified as a “proxy” of client system 105 by configuring a browser on client system 105. In an alternate embodiment, bridgeport 115 is identified as a “proxy” of client system 105 by so configuring ISP 110.

In due course of operation, ISP 110 receives a content request from client system 105, step 210. The request is routed to the bridgeport 115 as specified, step 225.

Upon receipt of the request, bridgeport 115 checks whether there is additional content for the request, step 230. In one embodiment, bridgeport 115 maintains a database of all network servers, e.g., network server 125, for which additional content is to be added. Bridgeport 115 checks whether the destination server identifier of a request (for example, the URL of the network server being targeted) matches any network server identifiers in its database. If a match is detected, then a marked identifier of the appropriate additional content is provided to client system 105. It one embodiment, this additional content is data to be displayed by the client system and the marked identifier of the additional content is a “marked” URL identifying where the additional content can be retrieved. Marked versions of URLs are discussed in more detail below. In an alternate embodiment, the additional content is stored at the bridgeport and the additional content itself is returned to the client system rather than an identifier of the additional content.

If there is no additional content for the request, then the request is placed onto the Internet, step 220. However, if there is additional content for the request, then both the marked identifier of the additional content and a marked version of the original request are sent to client system 105, step 235. The marked version of the original request includes a marking which identifies to the bridgeport that additional content for the request has already been identified to client system 105, thereby preventing the bridgeport from re-identifying additional content for the same request to client system 105.

Upon receipt of the marked identifier of the additional content and the marked version of the original request, the client system obtains and displays the additional content and resends the marked request to the ISP, step 240. In one embodiment, the additional content is obtained by sending the marked identifier of the additional content to the ISP for forwarding to the identified server or bridgeport. ISP 110 receives the marked request(s), which in turn are forwarded to bridgeport 115, step 245. Upon receipt of the marked request(s), bridgeport 115 removes the marking(s) and places the request(s) onto the Internet, step 250. Alternatively, bridgeport 115 responds to requests which target bridgeport 115 rather than placing those requests onto the Internet. In due course, the requested content is returned to client system 105. Thus, the client system displays the requested content which will be retrieved from the network server accompanied by the additional content identified and/or provided by the bridgeport.

In one embodiment, the additional content offers a service to client system 105. In one embodiment, bridgeport 115 also provides the service. In one implementation, the additional content offers a Push-To-Talk™ option. Push-To-Talk™ is a trademark of eFusion™, Inc. of Beaverton, Oreg. The Push-To-Talk™ option indicates to client system 105 that by selecting the Push-To-Talk™ option, a representative of the network server can be contacted by phone. In one embodiment, the phone call is established and facilitated by bridgeport 115 without requiring the user to enter or know the PSTN extension of the representative. By way of example, the network server may include content regarding eFusion™, Inc., and the Push-To-Talk™ option allows the user of client system 105 to talk to a representative of eFusion™ , Inc. without ending the data communication session or having to provide or know the telephone number for eFusion™ , Inc. It is to be appreciated that this representative could be a local representative, or could be a representative located anywhere throughout the world (e.g., a toll-free telephone number could be used).

To support the Push-To-Talk™ option, one embodiment of bridgeport 115 maintains a list of telephone numbers which correspond to representatives of associated network servers. If the Push-To-Talk™ option is activated by an individual at client system 105 then bridgeport 115 can facilitate a call to the representative to be established using the stored telephone number. A packet based phone call from client system 105 is caused to be made to bridgeport 115, which in turn is converted into a PSTN voice call to the representative. A discussion of automatic placement and facilitation of a telephone call to a PSTN extension from a networked client computer is disclosed in copending U.S. patent application Ser. No. <insert application serial number>, docket no. 002784.P003, filed contemporaneously with the present application, entitled, “Method and Apparatus for Establishing a Voice Call to a PSTN Extension for a Networked Client Computer”, which is hereby fully incorporated by reference.

It is to be appreciated that the additional content identified and/or provided by the bridgeport can be virtually any type of information. For example, additional local advertisements, or sale items specific to a particular geographic region could be identified. It is also to be appreciated that this additional content could be the same for all network servers, or could be network server-specific. The additional content may or may not include links to different services or HTML compatible web pages. A request by a user for a link which was part of the additional content is handled by the ISP and the bridgeport in like manner.

In an alternate embodiment, the bridgeport can be identified as a “proxy” to the client system by having the ISP query the client system. This querying can be done at any of a wide range of times, such as when the client system first sets up an account with the ISP, or each time the client system connects to the Internet via the ISP.

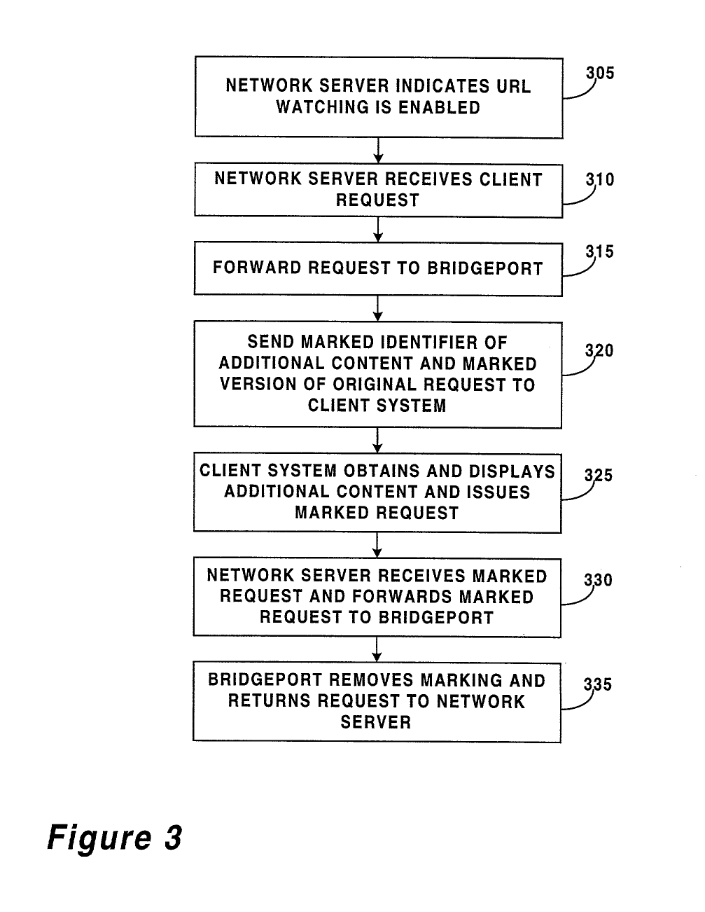

FIG. 3 is a flowchart illustrating the steps followed in the value added content delivery according to another embodiment of the present invention. In the flowchart of FIG. 3, it is presumed that the bridgeport 130 of FIG. 1 is providing the identifier of the additional content. Network server 125 first identifies bridgeport 130 as a “filter” for all requests it receives, step 305.

In due course of operation, network server 125 receives a client request from client system 105, step 310. Upon receipt of the request, the request is forwarded to bridgeport 130, step 315. Bridgeport 130 then sends both a marked identifier of the additional content and a marked version of the original request to client system 105, step 320. The marked version of the original request includes a marking which identifies to any bridgeport that additional content for the request has already been identified to client system 105.

Upon receipt of the marked identifier of the additional content and the marked version of the original request, client system 105 obtains and displays the additional content and resends the marked request onto the Internet, step 325. Network server 125 receives the marked request, and as before, the marked request is routed to bridgeport 130, step 330. Upon receipt of the marked request, the bridgeport removes the marking and returns the request to network server 125, which in turn returns the requested content to client system 105, step 335. Thus, client system 105 displays the requested content which will be retrieved from the network server accompanied by the additional content identified by the bridgeport.

In one embodiment, all requests for content from a particular network server receive the same additional content regardless of which content of the particular network server is accessed. In alternate embodiments, bridgeport 130 maintains a list of different additional content for different server content. By way of example, specific pages of content on the network server may correspond to different additional content which is to be sent to the client system. Upon receipt of a request, the bridgeport checks which page of content was accessed and forwards the corresponding additional content identifier to the client system.

It should be noted that identifiers of additional content may be added by multiple bridgeports for the same request. For example, bridgeports 115 and 130 of FIG. 1 may both identify additional content to the client system. In one embodiment, the markings added to the requests contain two parts: a first generic part which identifies that a bridgeport has marked the request, and a second bridgeport-specific part which uniquely identifies a particular bridgeport. Each bridgeport marks requests with its own unique identifier. Thus, all bridgeports adding content and/or content identifiers will recognize marked requests, yet only remove those markings which they added. However, it will be appreciated by those skilled in the art that a multiple-part marking need not be used if only one bridgeport will be adding content and/or content identifiers.

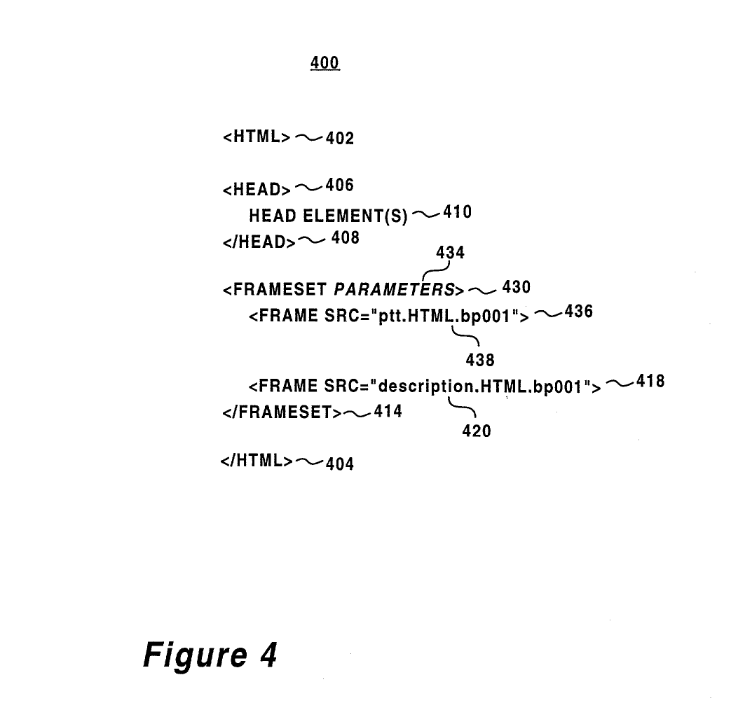

In another embodiment of the present invention, the client system assumes responsibility for the value added content delivery. For example, a process executing at the client system is configured to send an inquiry to the bridgeport inquiring whether there is additional content for a request (e.g., a particular URL) entered at the client system's web browser. The inquiry includes the URL of the request. Depending on the particular web browser, this process may intercept the request prior to the web browser beginning to retrieve the request, or alternatively may receive the request from the web browser as the browser begins to process the request. The bridgeport responds to the inquiry either by indicating that there is no additional content for the request or by sending both the identifier of the additional content and the request to the client system. Alternatively, rather than returning an identifier of the additional content, the additional content itself may be returned. In one implementation, the identifier of the additional content and the request returned are as discussed below with reference to FIG. 4. In another implementation, the identifier and the request returned are not marked. If there is no additional content for the request, then the process allows the web browser to begin and/or continue processing the request, resulting in the web browser placing the request onto the Internet. However, if there is additional content for the request, then the process provides the returned request and identifier of the additional information to the web browser. The web browser then proceeds to process the request and the identifier of additional content, resulting in the web browser placing the request and possibly the identifier onto the Internet with or without going through the bridgeport, depending on whether the identifier and the request were marked. It is to be appreciated that whether the identifier is placed onto the Internet also depends on whether the identifier of the additional information identifies a network server accessed via the Internet or a bridgeport which can be accessed without going through the Internet, such as bridgeport 115 of FIG. 1.

According to one embodiment of the present invention, the additional content is provided by a network server or the bridgeport in an HTML page format. FIG. 4 illustrates an example of source code with an identifier of additional content provided by an exemplary computer server to the client system. In FIG. 4, it is presumed that the client system issued a request for the content with an identifier of “description.HTML”.

An HTML page can be made up of one or more frames which can be organized hierarchically. A frame refers to a portion of the screen on which the page is to be displayed in which the content of the page is actually displayed. The content within these frames can be scrolled in a conventional manner, such as by using scroll bars. The size of a frame and its location on a screen is defined by the HTML page and is user adjustable.

The source code 400 illustrated in FIG. 4 defines an HTML page using the <HTML>402 and </HTML>404 commands. The source code 400 defines a document head with the <HEAD>406 and </HEAD>408 commands. The elements 410 displayed in the head include, for example, a title for the page and are defined between the commands 406 and 408.

The body of a framed HTML page is identified using the <FRAMESET>430 and </FRAMESET>414 commands. The content of the frames is defined using the FRAME commands 436 and 418. In the page illustrated in FIG. 4, a marked identifier of additional content has been added to the page using FRAME command 436. This additional content identifier is marked URL 438. The original URL requested by the client system is identified in the FRAME command 418 with marked URL 420. The size and location of the frames as they will be displayed at the client system is identified by parameters 434.

In the page illustrated in FIG. 4, the original URL request was for “description.HTML”, and the marking added to the URL request as well as to the additional content identifier is “.bp001”. In this example, the “bp” indicates that the request has been marked by a bridgeport, and the “001” indicates which bridgeport marked the request. It is to be appreciated that this marking is only an example, and that any of a wide range of markings and encodings could be used.

It should be noted that by adding the additional frame using the FRAME command, the substance of the content received from the network server remains unchanged. That is, the user at the client system will view the same content, except that an additional frame (for example, display window) will accompany the content.

It should also be noted that although only a single additional frame is added to the HTML page illustrated in FIG. 4, any number of additional frames can be added within the spirit and scope of the present invention. Additional frames can be added by, for example, adding additional FRAME commands.

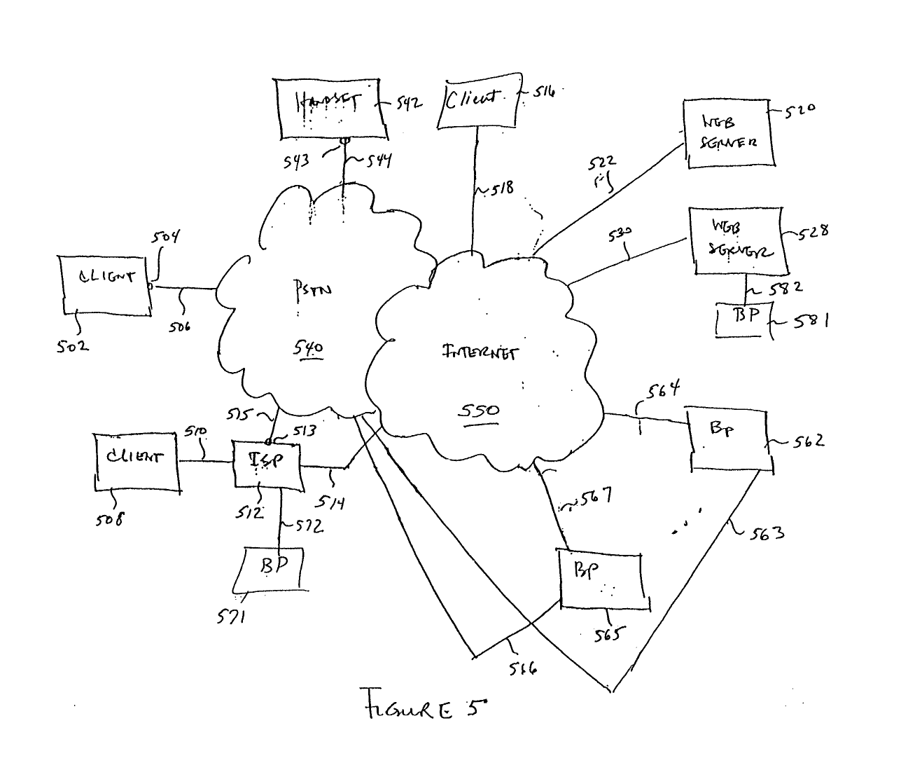

Referring now to FIG. 5, a block diagram is presented illustrating an exemplary communication system 500 incorporating the teachings of the present invention for value added content delivery. While the present invention will be described in the context of this exemplary communication system, based on the descriptions to follow, those skilled in the art will appreciate that the present invention is not limited to this embodiment, and may be also practiced with an Intranet (in lieu of the Internet). In one implementation, client system 502, ISP 512, bridgeport 571, web server 528, and bridgeport 581 of FIG. 5 are client system 102, ISP 110, bridgeport 115, network server 125, and bridgeport 130 of FIG. 1, respectively.

Client system 502, web servers 520 and 528, bridgeports 562, 565, 571, and 581, and handset 542 are communicatively coupled to each other by way of PSTN 540 and Internet 550 as shown. More specifically, client system 502 is coupled to Internet 550 by way of ISP 512. Client system 502 is coupled to ISP 512 through PSTN extension 504, communication line 506 and PSTN 540. In other words, for the illustrated embodiment, client system 502 includes a modulation/demodulation (MODEM) device (not shown) coupled to PSTN extension 504. However, a client computer may be coupled to ISP 512 through a network connection using a network interface instead, such as client computer 508 using network connection 510. Alternatively, a client computer may also be directly coupled to Internet 550.

Web servers 520 and 528 are coupled to Internet 550 through connections 522 and 530. Although not illustrated, web servers 520 and 528 may also be coupled to PSTN 540. Similarly, bridgeports 562 and 565 of the present invention are coupled to Internet 550 through connections 564 and 567. Bridgeports 562 and 565 are also coupled to PSTN 540 through communication lines 563 and 566 respectively. Handset 542 is coupled to PSTN 540 through PSTN extension 543 and communication line 544.

Communication lines 506, 515 and 544 may simply be plain old telephone service (POTS) communication lines, although other types of communication lines may be used. For examples, in the case of communication line 506, it may be an integrated service digital network (ISDN) line, whereas in the case of communication line 515, it may be a T1 (1.533 Mbps) or an E1 (2.0488 Mbps) trunk line. In the case of communication line 544, it may be a wireless cellular connection.

PSTN 540 includes a number of Service Switching Points (SSP), Signal Transfer Points (STP), and Service Control Points (SCP) coupled to each other (not shown). PSTN extension 504 through communication line 506 is coupled to a “local” SSP, which in turn is coupled to a number of other “local” PSTN extensions, including e.g. PSTN extension 513 if ISP 512 is a “local” ISP served by the same SSP. In addition, the “local” SSP is also coupled to an associated STP, which in turn is coupled to other “remote” SSPs. Each of the “remote” SSPs is coupled to a number of “remote” PSTN extensions, including e.g. extension 543, if handset 542 is a “remote” handset served by a “remote” SSP. As is well known in the art, Internet 550 includes a number of networks interconnected by routers, interconnecting the various client computers, web servers and bridgeports together. It is to be appreciated that Internet 550 may be a private Intranet instead.

Client system 502 is intended to represent a broad category of Internet enabled computer systems known in the art. An example of such a computer system is a desktop computer system equipped with a high performance microprocessor, such as the Pentium® processor manufactured by Intel Corporation of Santa Clara, CA or the Alpha® processor manufactured by Digital Equipment Corporation of Manard, Mass.; a communication interface for sending and receiving various data packets (including audio data packets) in accordance with certain standard communication protocol, such as a V.42bis compliant modem or an Ethernet adapter card; a windows-based operating system including internetworking communication services providing support for Transmission Control Protocol/Internet Protocol (TCP/IP) (and other Internet Communication Suite protocols) and socket services, such as Windows™ 95 developed by Microsoft Corporation of Redmond, Wash.; and a web communications tool such as Navigator™, developed by Netscape Communications of Mountain View, Calif..

In the illustrated embodiment, client system 502 is also equipped with a number of audio input and output peripherals/interfaces for inputting, digitizing and compressing outbound audio, and for decompressing and rendering inbound audio, and an Internet telephony application, such as IPhone¹ developed by Intel Corporation. However, it is to be appreciated that alternate embodiments need not be so equipped. ¹ Note that it is not necessary for the Internet telephony application to explicitly support voice calls with PSTN handsets, as is the case with IPhone and many of the prior art Internet telephony applications.

In one embodiment, client system 502, while in data communication with a web server, e.g. web server 528, through PSTN 540 and Internet 550, is presented with an added Push-To-Talk™ option by the bridgeport 571. When client system 502 selects the Push-To-Talk™ option, bridgeport 571 of the present invention automatically determines the PSTN extension of telephone handset 542 as the appropriate destination PSTN extension, as well as an appropriate one of the community of bridgeports 562 and 565 to place the voice call to the PSTN extension and facilitate the voice call between the user of client system 502 and the user of telephone handset 542. In one embodiment, the PushTo-Talk™ option is pre-associated with bridgeport 571 for web server 528 by bridgeport 571, and the determination of the destination PSTN extension by bridgeport 571 is made in accordance with one or more attributes of web server 528, such as the identity of web server 528, and optionally, one or more attributes of client system 502, such as the zip code of the area in which client system 502 is located.

Except for web pages having Push-To-Talk™ options pre-associated with the bridgeports of the present invention being added, web servers 520 and 528 are intended to represent a broad category of web servers, including e.g. corporate presence servers and government presence servers, known in the art. Any number of high performance computer servers may be employed as web servers 520 and 528, e.g. a computer server equipped with one or more Pentium® Pro processors from Intel Corp., running Microsoft's Windows® NT operating system, or a computer server equipped with one or more SPARC® processors from Sun Microsystems of Mountain View, Calif., running Sun's Solaris® operating system.

Similarly, except for its association with bridgeport 571, ISP 512 is intended to represent a broad category of Internet service providers. An ISP may be a “small” local Internet access provider, or one of a number of point of presence providers offered by a “large” ISP. It is also anticipated that ISP 512 may be incorporated with bridgeport 571 and/or an SSP of PSTN 540. Handset 542 is intended to represent a broad category of conventional handsets known in the art, including but not limited to desktop handsets, cordless handsets, and wireless handsets. No special features are required of handset 542 for it to be called and connected to Internet telephony enabled client system 502, in accordance with the present invention. As described earlier, handset 542 may also be automated/computerized telephony answering equipment.

Before we proceed to describe bridgeports 571, 581, 562, and 565 in further detail, it should be noted that one skilled in the art of, e.g., telecommunications, will appreciate that the communication system illustrated in FIG. 5, is significantly more complex than what is depicted. For example, each SSP of PSTN 540 may service thousands of PSTN extensions, and there are numerous SSPs, STPs and SCPs in a common PSTN implementation. Internet 550 includes well over several hundred thousands of networks. Together, PSTN 540 and Internet 550 interconnects millions of client computers and web servers. Nonetheless, FIG. 5 does capture a number of the more relevant components of communication system necessary to illustrate the interrelationship between client system 502, web server 528, bridgeports 562 and 568, and handset 542, such that one skilled in the art may practice the present invention. Also, while the present invention is being described in the context of client system 502 being engaged in data communication with web server 528, as will be readily apparent from the description to follow, the present invention may be practiced with any “client” computer engaged in data communication with any “web” or “information” server.

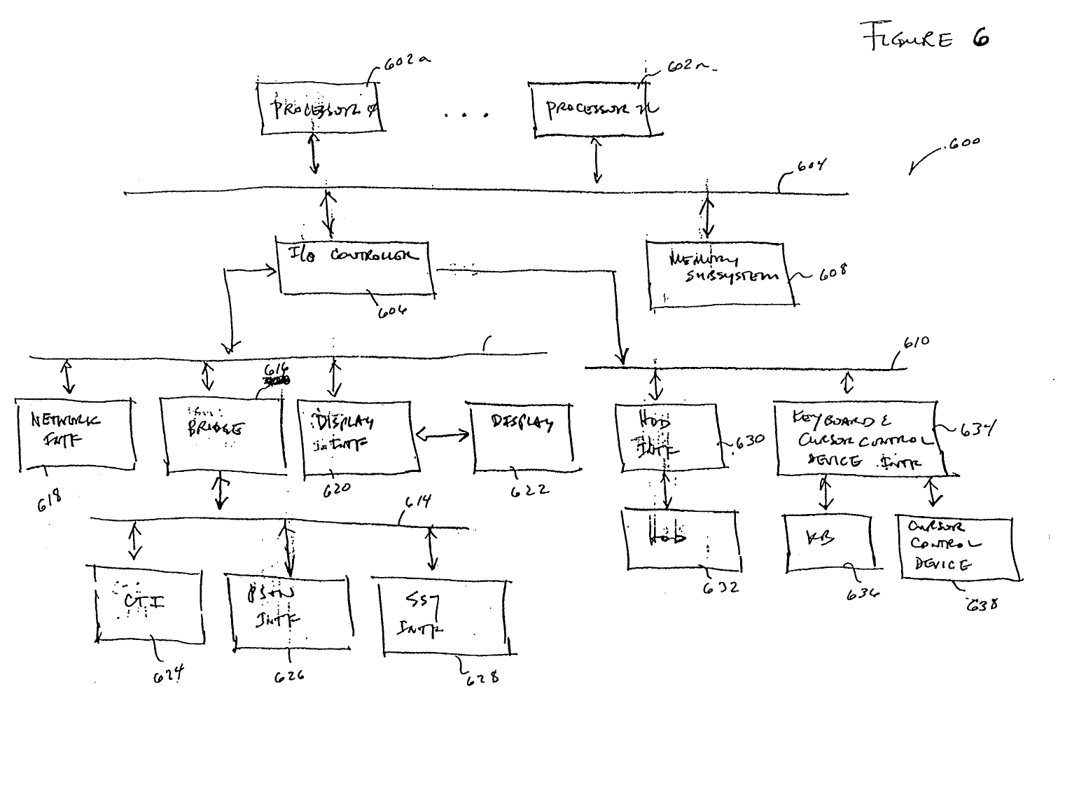

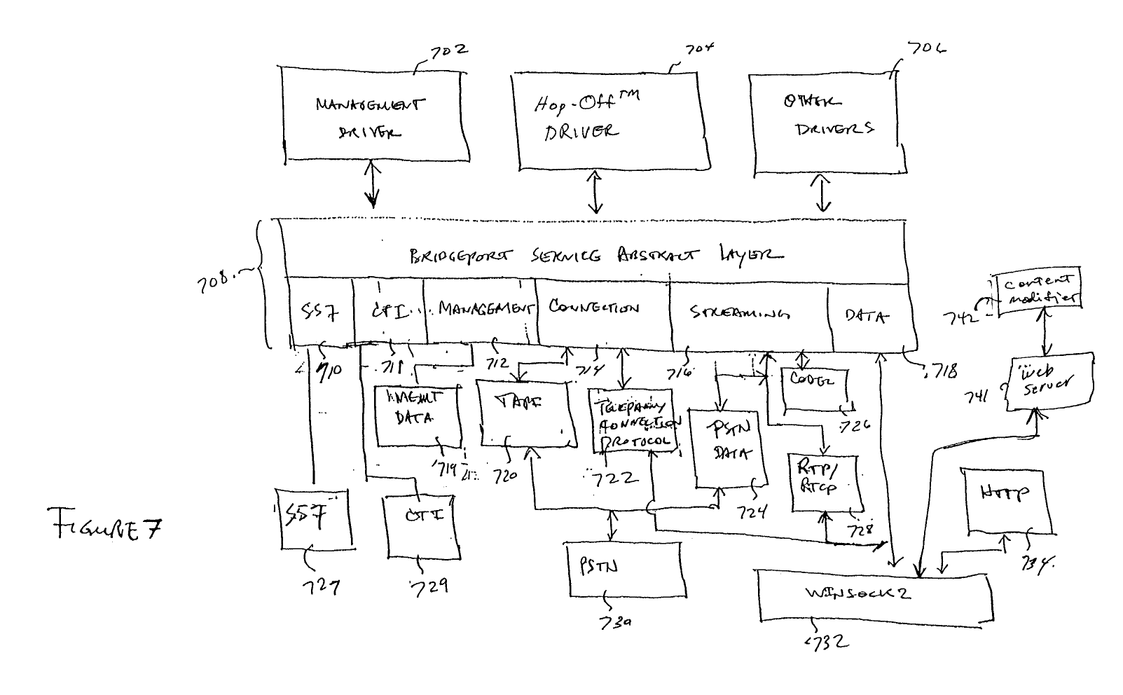

Turning now to FIGS. 6 and 7, two block diagrams illustrating the hardware and software elements of an exemplary computer server 600 suitable to be employed as a bridgeport are depicted. As illustrated, exemplary computer server 600 is comprised of multiple processors 602a-602n and memory subsystem 608 coupled to processor bus 604 as depicted. Additionally, computer server 600 is comprised of a second bus 610, a third bus 612 and a fourth bus 614. In one embodiment, buses 612 and 614 are Peripheral Component Interconnect (PCI) buses, while bus 610 is an Industry Standard Architecture (ISA) bus. PCI buses 612 and 614 are bridged by bus bridge 616, and bridged to ISA bus 610 and processor bus 604 by I/O controller 606. Coupled to PCI bus 612 are network interface 618 and display interface 620, which in turn is coupled to display 622. Coupled to PCI bus 614 is computer telephony interface (CTI) 624, PSTN interface 626 and SS7 Interface 628. Coupled to ISA bus 610 are hard disk interface 630, which in turn is coupled to a hard drive 632. Additionally, coupled to ISA bus 610. keyboard and cursor control device 634, which in turn is coupled keyboard 636 and cursor control device 638.

CTI interface 624 provides the necessary hardware to interface exemplary computer server 600 to telephony equipment, such as private branch exchange (PBX) equipment. PSTN interface 626 provides the necessary hardware to interface exemplary computer server 600 to a plurality of PSTN communication lines (e.g., T1, E1 or POTS), wherein the actual number of PSTN communication lines interfaced will be implementation dependent. Additionally, PSTN interface 626 provides advanced DSP-based voice, dual-tone multiple frequency (DTMF) and call progress functionality, which allows for downloadable DSP protocol and voice processing algorithms, thereby providing CODEC support locally on the interface. Examples of supported codecs include the Global System for Mobile Communications (GSM) codec and the ITU-T G.723.1 protocol codecs, the specification for which are commonly available from the GSM consortium and the International Telecommunications Union, respectively. Similarly, SS7 interface 628 provides the hardware necessary to interface exemplary computer server 600 with PSTN trunk lines (e.g., ISDN) supporting the out-of-band communication protocol (e.g., SS7)) used between PSTN network elements (i.e., SSP-SSP, SSP-STP, STP-SCP, etc.). In one embodiment, PSTN interface 626 is preferably an AG-T1™ (for U.S. implementations, while an AG-El may be seamlessly substituted for European implementations), while SS7 interface 628 is preferably the TX300OTM, both of which, along with their accompanying software drivers, are manufactured by and commonly available from Natural MicroSystems of Natick, Mass. Otherwise, all other elements, processors 602a-602n, memory system 608 and so forth perform their conventional functions known in the art. Insofar as their constitutions are generally well known to those skilled in the art, they need not be further described.

From a software perspective, FIG. 7 illustrates the software elements of exemplary computer server 600. In particular, exemplary computer server 600 is shown comprising an application layer consisting of a Bridgeport Management Driver 702, Hop-Off™ driver 704, and other drivers 706. Hop-Off™ is a trademark of eFusion™, Inc. of Beaverton, Oreg.

The Service Abstraction Layer (SAL) 708 is shown comprising SS7 services 710, CTI Services 711, Management Services 712, Connection Services 714, Streaming Services 716, and Data Services 718. The protocol/service layer is shown comprising Telephony Application Programming Interface (TAPI) 720, Telephony Connection Protocol 722, PSTN Data Interface 724, CODEC 726, Real Time (Streaming) Protocol 728, HTTP server 734, and web server 741. Also shown in this “layer” are configuration management data 719 maintained by management service 712, and codec services 726 employed by streaming services 716. The driver layer is shown comprising SS7 driver 727, CTI driver 729, PSTN driver 730 and socket service 732. Data and control information are exchanged between these elements in the fashion depicted.

Within the context of the present invention, one purpose of SAL 708 is to provide an Application Programming Interface (API) for all the available bridgeport and related services in exemplary computer server 600. The API abstracts out the actual modules used for providing services such as connection establishment (714), streaming and data exchange services (716 and 718). Additionally, SAL 708 provides the common operation tools such as queue management, statistics management, state management and the necessary interface between the plug-in services (i.e., drivers in the driver layer). SAL 708 is also responsible for loading and unloading the appropriate drivers as appropriate.

Connection service 714 includes a connection establishment and tear-down mechanism facilitating the interconnection to the PSTN 140. Additionally, for the illustrated embodiment, connection service 714 employs connection and compatibility services which facilitate interoperation between communication equipment that support industry standards, thereby allowing a variety of communication equipment manufactured by different vendors to be benefited from the present invention. Connection services 714 include, in particular, services for supporting standard video telephony, such as ITU-T's H.323 video telephony, and standard data communication, such as ITU-T's T.120 data communication protocol. Examples of the connection establishment and tear-down mechanisms supported by connection service layer 714 include opening and starting PSTN ports, call control, DTMF collection, and tone generation, to name but a few.

Streaming service 716 is responsible for interfacing with the components that provide the real-time streaming functionality for the multimedia data. Once the connection has been established between the connection points (i.e., PSTN, H.323, etc.), streaming service 716 will take over the management and streaming of data between the two connected parties, until the connection is terminated. Codec service 726 facilitates the above described compression and transmission of inbound call signals from handset 142 as well as decompression and transmission of outbound call signals from client computer 102.

Data service 718 is responsible for providing non real-time peer to peer (i.e., computer-computer) messaging and data exchange between exemplary computer server 600 and other Internet and perhaps PSTN based applications. Sending messages to exemplary computer server end-points (i.e., other similarly equipped bridgeports on the Internet) or other servers within the PSTN is accomplished via data service 718.

CTI services 711 service all communications and automatic call distribution (ACD) necessary for Private Branch Exchange (PBX) based systems. SS7 services 710 service all out of band communications with STPs and/or SCPs of PSTN 140.

PSTN driver 730 is equipped to accommodate particularized PSTN interfaces 626, whereas CTI driver 729 is equipped to support particularized ACD and PBX equipment. Similarly, SS7 driver 727 is equipped to support particularized SS7 interface 628.

Web server 741 is equipped to provide web service with the Internet. In one embodiment, web server 741 is a web server developed by Microsoft Corporation of Redmond, Wash. In the illustrated embodiment, content modifier 742 implements the value added content delivery services described earlier. In other words, content modifier 742 is a “pre-processing function” of server 741. In the context of Microsoft's web server, content modifier 742 is Microsoft web server's filter.

In one embodiment, the portions of the method and apparatus for value added content delivery discussed above which are implemented at the bridgeport are implemented as a series of software routines which are drivers 702 and 706, and content modifier 742 of FIG. 7. These software routines comprise a plurality or series of instructions to be executed by a processor(s) in a hardware system, such as processors 602a-602b of FIG. 6. Initially, the series of instructions are stored on a storage device, such as hard drive 632. The instructions are copied from hard drive 632 into memory subsystem 608 and then accessed and executed by one or more processor(s) 602a-602b. In one implementation, these software routines are written in the C++ programming language. It is to be appreciated, however, that these routines may be implemented in any of a wide variety of programming languages. In alternate embodiments, the present invention is implemented in discrete hardware or firmware. For example, an application specific integrated circuit (ASIC) could be programmed with the above described functions of the present invention.

In several of the discussions above, the network environment is described as being the Internet. It is to be appreciated, however, that the present invention can be used with any type of network environment and is not limited to the Internet. By way of example, the present invention could also be used with a local area network (LAN) or an Intranet.

Also in the discussions above, the present invention is described as being implemented in a bridgeport coupled to an Internet Service Provider. However, it is to be appreciated that the present invention can be implemented in any of a wide range of devices. For example, the present invention can be used in a gateway system which sits between a local area network (LAN) and an external network such as the Internet. In this example, the present invention operates to add content to the content provided by network servers accessed by the requesting client systems on the LAN.

Additionally, it is to be appreciated that although the present invention is discussed as providing additional content which can be displayed by a client system, the present invention is not limited to visually based content. For example, the additional content could be audio content.

Thus, the present invention provides a method and apparatus for value added content delivery. The present invention advantageously allows additional content to be added to the content received from a host system, thereby allowing additional content to be displayed at a client system without requiring a change in the content at the host system. A wide variety of additional content can be provided by the present invention, thereby advantageously enhancing the content received from the host system.

Whereas many alterations and modifications of the present invention will be comprehended by a person skilled in the art after having read the foregoing description, it is to be understood that the particular embodiments shown and described by way of illustration are in no way intended to be considered limiting. References to details of particular embodiments are not intended to limit the scope of the claims.

What is claimed is:

1. A method comprising the steps of:
(a) receiving either a request for content from a client system which targets a network server or an additional content inquiry from the client system; and
(b) providing, in response to either receiving the request or the inquiry, additional content to the client system in other than the requested content.

2. The method of claim 1 wherein the providing step (b) comprises the step of providing additional information regarding the network server to selected client systems of a plurality of client systems which issue requests for content which target the network server.

3. The method of claim 1, wherein the providing step (b) comprises the step of providing the additional content without altering the substance of the requested content.

4. The method of claim 1, further comprising the step of checking whether additional content corresponding to the network server exists, and wherein the providing step (b) comprises the step of providing the requested content to the client system in response to the presence of the additional content corresponding to the network server.

5. The method of claim 1, further comprising the step of forwarding the request to the network server via the Internet.

6. The method of claim 1, wherein the additional content comprises an option for making a telephone call.

7. The method of claim 6, wherein the additional content comprises an option for making a telephone call without requiring provision of a telephone number by a user.

8. The method of claim 6, wherein the additional content comprises an option for making a telephone call without termination of a current client system to network communication session.

9. The method of claim 1, wherein the method further comprises a step of automatically establishing and facilitating a voice call to a PSTN handset in response to a user's selection of the additional content.

10. The method of claim 1, wherein the providing step (b) comprises the step of providing an identifier of additional content to the client system.

11. The method of claim 10, wherein the identifier of additional content comprises a Uniform Resource Locator (URL).

12. The method of claim 1, wherein the receiving step (a) comprises the step of receiving the request prior to forwarding the request to the network server via the Internet.

13. The method of claim 1, further comprising the step of returning a marked version of the request to the client system.

14. The method of claim 13, further comprising the steps of:
receiving the marked version of the request from the client system;
checking whether a current bridgeport of a plurality of bridgeports marked the request; and
removing the marking from the request provided the current bridgeport marked the request.

15. The method of claim 13, wherein the marked version of the request comprises a Uniform Resource Locator (URL) corresponding to the request appended with additional characters.

16. The method of claim 1, further comprising the step of returning a HyperText Markup Language (HTML) page to the client system, wherein the HTML page includes a marked version of the request and a marked identifier of the additional content.

17. The method of claim 1, further comprising the step of returning a HyperText Markup Language (HTML) page to the client system, wherein the HTML page includes the request and an identifier of the additional content.

18. The method of claim 1, further comprising the step of returning a HyperText Markup Language (HTML) page to the client system, wherein the HTML page includes a marked version of the request and the additional content.

19. An apparatus comprising:
a database which stores identifiers of additional content;
control logic operative to check whether a request for content from a client system targets one of one or more network servers or whether an additional content inquiry has been received; and
content-adding logic, coupled to the control logic, operative to provide an identifier of additional content to the client system in addition to the requested content.

20. The apparatus of claim 19, wherein the identifier of additional content stored in the database is network server-specific.

21. The apparatus of claim 19, wherein the identifiers comprise Uniform Resource Locators (URLs).

22. The apparatus of claim 19, wherein the apparatus further comprises logic operative to automatically establish and facilitate a voice call to a PSTN handset in response to selection of the additional content.

23. The apparatus of claim 22, wherein the additional content comprises an option to activate the logic operative to automatically establish and facilitate a voice call to a PSTN handset.

24. A method comprising the steps of:
(a) receiving either a request for content from a client system which targets a network server or an additional content inquiry from the client system; and
(b) providing, in response to either receiving the request or the inquiry, an identifier of additional content other than the requested content to the client system.

25. The method of claim 24, wherein the additional content comprises an option for making a telephone call.

26. The method of claim 19, wherein the additional content comprises an option for making a telephone call without requiring provision of a telephone number by a user.

27. The method of claim 24, wherein the additional content comprises an option for making a telephone call without termination of a current client system to network communication session.

28. The method of claim 24, wherein the identifier of additional content comprises a Uniform Resource Locator (URL).

29. A client system comprising control logic operative to receive, as an input, a first request which targets a first network server, to send an additional content inquiry to a first component other than the first network server, to subsequently send the request to the first network server, and to conditionally send a second request to a second component to obtain additional content based on a response to the additional content inquiry from the first component.

30. The client system of claim 29, wherein the second component comprises a second network server.

31. The client system of claim 29, wherein the first component comprises a bridgeport.

32. The client system of claim 29, wherein both the first request and the second request are each Uniform Resource Locators (URLs).
